(19) United States
(12) Patent Application Publication
(10) Pub. No.: US 2022/0376783 A1
(43) Pub. Date: Nov. 24, 2022

(54) RECEIVER, TRANSCEIVER, SPATIAL OPTICAL FREQUENCY TRANSMISSION SYSTEM, AND SPATIAL OPTICAL FREQUENCY TRANSMISSION METHOD

(71) Applicant: Nippon Telegraph and Telephone Corporation, Tokyo (JP)

(72) Inventors: Hiroki SAKUMA, Musashino-shi, Tokyo (JP); Kaoru ARAI, Musashino-shi, Tokyo (JP); Ryuta Sugiyama, Musashino-shi, Tokyo (JP)

(21) Appl. No.: 17/776,059

(22) PCT Filed: Nov. 19, 2019
(86) PCT No.: PCT/JP2019/045305

§ 371 Date: May 11, 2022

(51) Int. Cl. H04B 10/071; H04B 10/11

(52) U.S. Cl. CPC H04B 10/071; H04B 10/11

(57) ABSTRACT

A receiver (12) includes at least a spatial light modulation unit (12a), splitters (12b to 12d), a spatial filtering unit (12h), and a wavefront measurement unit (12i). The splitters (12b to 12d) transmit and reflect reference signal light of a reference optical frequency received via space (15) after being transmitted from a transmitter 11. The spatial filtering unit (12h) extracts a plane wave component, which is a signal component other than distortions, from the reflected light and outputs the extracted light as reference light. The wavefront measurement unit (12i) measures a wavefront due to the interference between the reference light and the reflected and transmitted signal light to detect a wavefront distortion of the reference signal light. The spatial light modulation unit (12a) wavefront-modulates the reference signal light received from the transmitter (11) into a plane wave without wavefront distortions with a reversed wavefront distortion obtained by reversing the detected wavefront distortion. That is, the wavefront modulation corrects the reference signal light into a plane wave without wavefront distortions.

### TECHNICAL FIELD

The present invention relates to a receiver, a transceiver, a spatial light frequency transmission system, and a spatial light frequency transmission method used to transmit signal light of a reference optical frequency between separated transmitters and receivers via space.

### BACKGROUND ART

Various fields such as scientific measurement, communication, and navigation require a technology for accurately transmitting reference frequency signals between transmitters and receivers that are separated from each other at remote locations or the like. In recent years, there have been optical frequency transmission systems that employ transmission of signal light of a reference optical frequency via space instead of transmission via optical fibers in order to expand the application range of frequency transmission technology. Such types of technology include those described in NPL 1 and 2.

A system based on a spatial light frequency transmission method of NPL 1 will be described. This system includes a transceiver on a transmitting side and a transceiver on a receiving side which are separated from each other. A main signal which is a light wave of a reference frequency is transmitted from the transmitting side to the receiving side via space. The receiving side returns the received main signal and transmits the return signal back to the transmitting side. The transmitting side detects a phase fluctuation from a beat signal which is the difference between the return signal and the main signal, and according to the detected phase fluctuation, the transmitting side applies a frequency shift capable of canceling out the phase fluctuation to the main signal. This makes the frequency of the main signal received by the receiving side constant, such that the receiving side can output signal light having a constant reference frequency to an optical fiber.

### CITATION LIST

### Non Patent Literature

NPL 1: Meng Cui, Changuei Yang, “Implementation of a digital optical phase conjugation system and its application to study the robustness of turbidity suppression by phase conjugation,” OPTICS EXPRESS, Vol. 18, No. 4, pp. 3444-3454, 15 Feb. 2010.
NPL 2: Tomohiro Maeda et al., “Holographic-Diversity Interferometry for Reference-Free Phase Detection,” 2013 Conference on Lasers and Electro-Optics Pacific Rim (CLEOPR), 30 Jun.-4 Jul. 2013.

### SUMMARY OF THE INVENTION

### Technical Problem

However, in the system of NPL 1 above, when a light wave which is a main signal is transmitted through space (atmosphere), the refractive index distribution of the atmosphere may fluctuate temporally or vary spatially, such that atmospheric fluctuations occur. This causes a wavefront distortion that is an altered wavefront of light. If wavefront distortions occur, the system may fail to operate normally.

Thus, a technique in which wavefront measurement is performed using reference light obtained by extracting a plane wave component from a received light wave of a reference frequency and wavefront modulation is performed according to the measurement result to correct wavefront distortions has been suggested in the related art. However, if the light intensity of the plane wave component in the received light is not sufficient, there are problems that the accuracy of wavefront measurement deteriorates and wavefront distortions cannot be corrected accurately.

The present invention has been made in view of such circumstances and it is an object of the present invention to accurately correct a wavefront distortion caused when a light wave of a reference frequency is transmitted through space.

### Means for Solving the Problem

In order to solve the above problems, a receiver of the present invention includes a beam splitter that transmits and reflects reference signal light of a reference optical frequency received from a transmitter via space, a spatial filtering unit that extracts a plane wave component other than distortions from the reference signal light reflected by the beam splitter and outputs extracted light as reference light, a wavefront measurement unit that measures a wavefront due to an interference between the reference light and the reference signal light reflected by the beam splitter to detect a wavefront distortion of the reference signal light, and a spatial light modulation unit that wavefront-modulates the reference signal light received from the transmitter into a plane wave without wavefront distortions with a reversed wavefront distortion obtained by reversing the wavefront distortion.

### Effects of the Invention

According to the present invention, it is possible to accurately correct a wavefront distortion caused when a light wave of a reference frequency is transmitted through space.

### BRIEF DESCRIPTION OF DRAWINGS

FIG. 1 is a block diagram illustrating a configuration of a spatial light frequency transmission system according to a first embodiment of the present invention.

FIG. 2 is a flowchart for explaining an operation of the spatial light frequency transmission system according to the first embodiment of the present invention.

FIG. 3 is a block diagram illustrating a configuration of a spatial light frequency transmission system according to a second embodiment of the present invention.

FIG. 4 is a flowchart for explaining an operation of the spatial light frequency transmission system according to the second embodiment of the present invention.

FIG. 5 is a block diagram illustrating a configuration of a spatial light frequency transmission system according to a first modification of the second embodiment of the present invention.

FIG. 6 is a block diagram illustrating a configuration of a spatial light frequency transmission system according to a second modification of the second embodiment of the present invention.

FIG. 7 is a block diagram illustrating a configuration of a spatial light frequency transmission system according to a third embodiment of the present invention.

FIG. 8 is a block diagram illustrating a configuration of a spatial light frequency transmission system according to a first modification of the third embodiment of the present invention.

FIG. 9 is a block diagram illustrating a configuration of a spatial light frequency transmission system according to a second modification of the third embodiment of the present invention.

### DESCRIPTION OF EMBODIMENTS

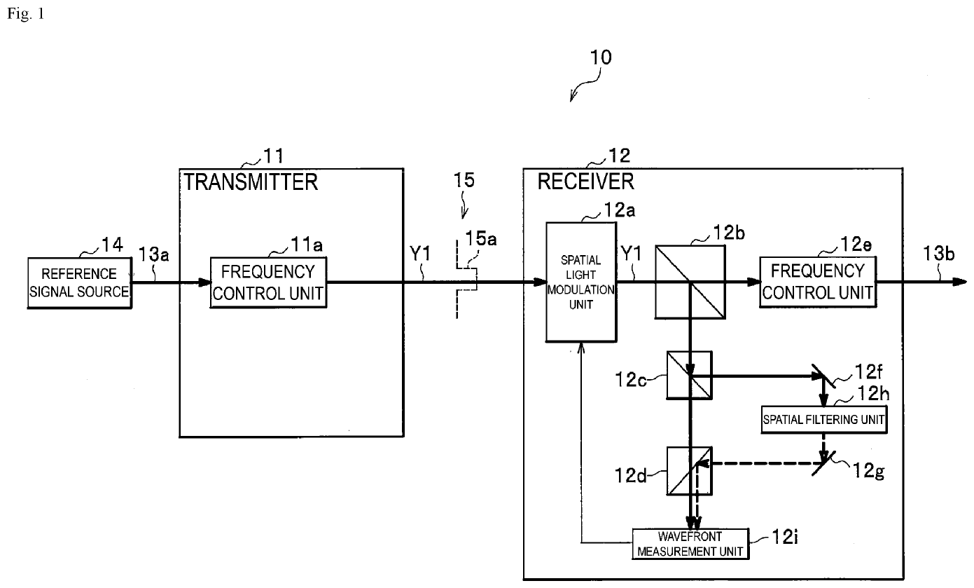

Hereinafter, embodiments of the present invention will be described with reference to the drawings. Components having corresponding functions are given the same reference signs in all drawings of the present specification and description thereof will be omitted as appropriate. Configuration of First Embodiment FIG. 1 is a block diagram illustrating a configuration of a spatial light frequency transmission system according to a first embodiment of the present invention.

The spatial light frequency transmission system (also referred to as a system) 10 illustrated in FIG. 1 includes a transmitter 11 and a receiver 12 that are separated from each other at remote locations or the like. The transmitter 11 includes a frequency control unit 11a, to which an external reference signal source 14 is connected via an optical fiber 13a. The receiver 12 is configured to include a spatial light modulation unit 12a, beam splitters (also referred to as splitters) 12b, 12c, and 12d, a frequency control unit 12e, mirrors 12f and 12g, a spatial filtering unit 12h, and a wavefront measurement unit 12i. The frequency control units 11a and 12e perform control for correcting frequency fluctuations.

The reference signal source 14 is a laser or the like and emits signal light of a reference optical frequency (also referred to as reference signal light). The frequency control unit 11a of the transmitter 11 couples the reference signal light to the optical fiber 13a. The coupled reference signal light is transmitted from the transmitter 11 to the receiver 12 via space 15.

In the receiver 12, each of the splitters 12b to 12d splits the reference signal light received via the spatial light modulation unit 12a into two, transmitted light and reflected light, at a predetermined ratio. In this example, the reference signal light is split at a ratio of 1:1. The frequency control unit 12e couples the reference signal light transmitted through the splitter 12b to an optical fiber 13b. This coupling is performed by focusing the signal light on the optical fiber 13b by a lens.

The spatial filtering unit 12h extracts a plane wave component which is a signal component other than distortions from the signal light reflected by the mirror 12f after being reflected by the splitters 12b and 12c and outputs the extracted plane wave component as reference light indicated by a dashed arrow. The plane wave component has a high light intensity because it has no distortions.

The principle of the spatial filtering unit 12h will now be described concretely. That is, the signal light incident from the mirror 12f is focused by a lens such that the plane wave component having a high light intensity is focused in the center. Thus, when the focused light is passed through a pinhole, only the plane wave component is passed through the pinhole and then used as reference light. The reference light is reflected by the mirror 12g, then reflected by the splitter 12d, and is incident on the wavefront measurement unit 12i.

The signal light reflected and transmitted by the splitters 12b to 12d is also incident on the wavefront measurement unit 12i. The wavefront measurement unit 12i measures a wavefront due to the interference between the incident signal light and the reference light to detect a wavefront distortion of the reference signal light. Here, the wavefront distortion can be properly detected because the reference light is a plane wave component having a high light intensity. The wavefront distortion is emitted to the spatial light modulation unit 12a.

The spatial light modulation unit 12a wavefront-modulates the reference signal light received from the transmitter 11 with a reversed wavefront distortion obtained by reversing the wavefront distortion from the wavefront measurement unit 12i to correct the reference signal light to a plane wave without wavefront distortions. The corrected reference signal light is emitted to the frequency control unit 12e via the splitter 12b. Hereinafter, incidence of light will also be referred to as input and emission of light will also be referred to as output.

### Operation of First Embodiment

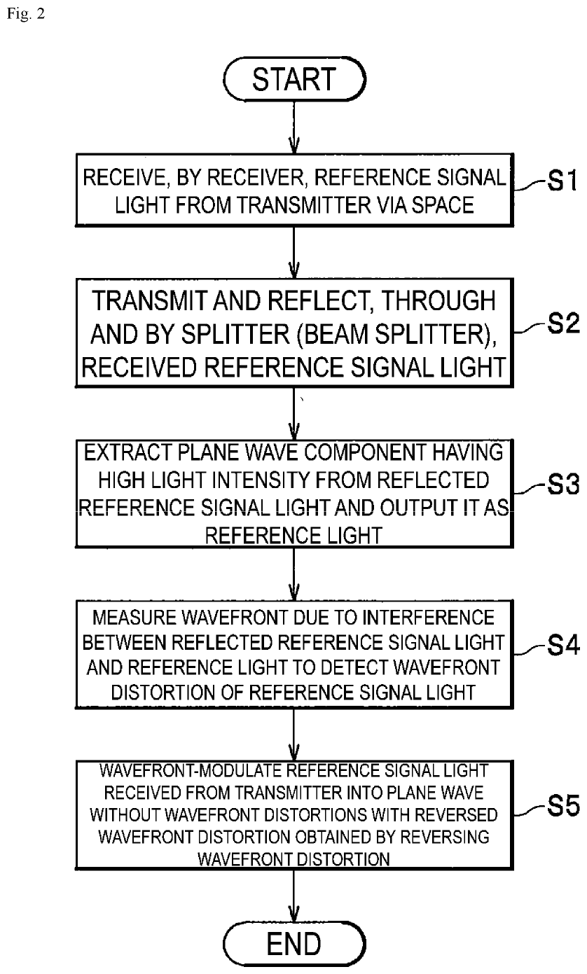

Next, an operation of the system 10 according to the first embodiment will be described with reference to a flowchart shown in FIG. 2.

First, reference signal light output from the reference signal source 14 is output to the transmitter 11 via the optical fiber 13a.

Next, in step S1 shown in FIG. 2, the reference signal light input to the transmitter 11 is transmitted to the space 15 via the frequency control unit 11a as indicated by an arrow Y1 and then received by the receiver 12. Here, it is assumed that a wavefront distortion that is an altered wavefront of light is caused to the reference signal light due to the influence of an atmospheric fluctuation 15a shown as a dashed pulse during transmission through the space 15.

In step S2, the reference signal light received by the receiver 12 is transmitted through and reflected by the splitter 12b via the spatial light modulation unit 12a. The reflected reference signal light is further reflected by the splitter 12c, further reflected by the mirror 12f, and input to the spatial filtering unit 12h.

In step S3, the spatial filtering unit 12h extracts a plane wave component having a high light intensity from the input signal light and outputs the extracted plane wave component to the mirror 12f as reference light. This reference light is reflected by the mirror 12f and the splitter 12d and input to the wavefront measurement unit 12i.

On the other hand, the reference signal light reflected by the splitter 12b is transmitted through the splitters 12c and 12d and input to the wavefront measurement unit 12i.

In step S4, the wavefront measurement unit 12i measures a wavefront due to the interference between the input signal light and the reference light to detect a wavefront distortion of the reference signal light and outputs the detected wavefront distortion to the spatial light modulation unit 12a.

In step S5, the spatial light modulation unit 12a wavefront-modulates the reference signal light received from the transmitter 11 with a reversed wavefront distortion obtained by reversing the input wavefront distortion to correct the reference signal light to a plane wave without wavefront distortions. The corrected reference signal light is transmitted through the splitter 12b and output to the frequency control unit 12e.

The frequency control unit 12e focuses and couples the reference signal light to the optical fiber 13b by a lens (not shown) to transmit the reference signal light. Here, because the reference signal light input to the frequency control unit 12e has been corrected to a plane wave without wavefront distortions, there are no fluctuations in the arrival angle of the light beam at the lens and fluctuations in the focused diameter of the light beam on the lens. Thus, most of the reference signal light is coupled to the optical fiber 13b, such that the reference signal light having a strong light intensity is transmitted through the optical fiber 13b.

### Advantages of First Embodiment

The receiver 12 of the system 10 of the first embodiment includes at least the spatial light modulation unit 12a, the splitters 12b, 12c, and 12d, the spatial filtering unit 12h, and the wavefront measurement unit 12i.

The splitters 12b to 12d transmit and reflect the reference signal light of the reference optical frequency received via the space 15 after being transmitted from the transmitter 11. The spatial filtering unit 12h extracts a plane wave component which is a signal component other than distortions from the reflected light that has been reflected by the splitter 12c and outputs the extracted light as reference light.

The wavefront measurement unit 12i measures a wavefront due to the interference between the reference light and the signal light reflected and transmitted by the splitters 12b to 12d to detect a wavefront distortion of the reference signal light.

The spatial light modulation unit 12a wavefront-modulates the reference signal light received from the transmitter 11 into a plane wave without wavefront distortions with a reversed wavefront distortion obtained by reversing the detected wavefront distortion. That is, the spatial light modulation unit 12a corrects the reference signal light to a plane wave without wavefront distortions by wavefront modulation.

According to this configuration, the spatial filtering unit 12h can extract a plane wave component which is a signal component other than distortions from the reference signal light received by the receiver 12. Because the plane wave component has a high light intensity, it is possible to prevent deterioration of the wavefront measurement accuracy of the wavefront measurement unit 12i and the spatial light modulation unit 12a can accurately correct wavefront distortions.

### Configuration of Second Embodiment

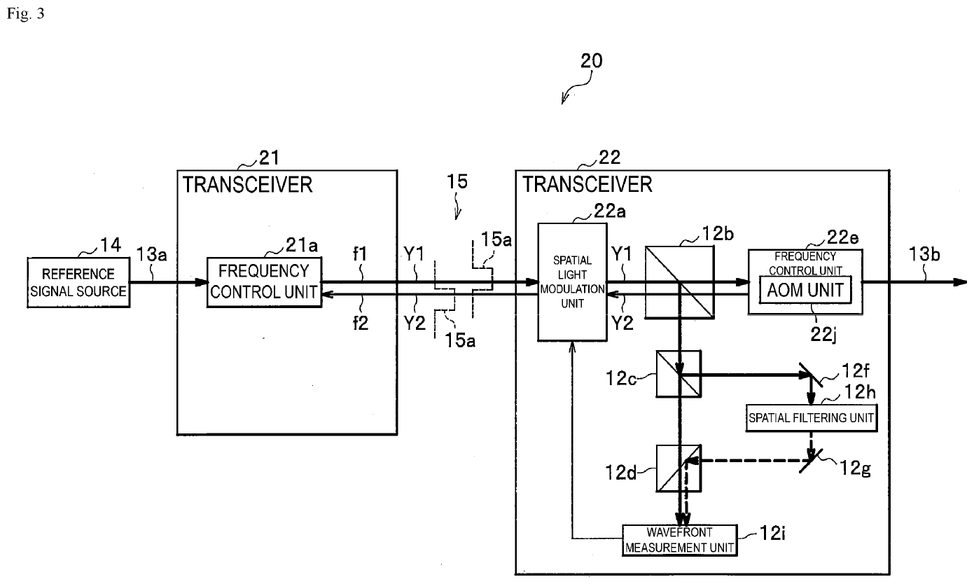

FIG. 3 is a block diagram illustrating a configuration of a spatial light frequency transmission system according to a second embodiment of the present invention.

The spatial light frequency transmission system 20 illustrated in FIG. 3 differs from the system 10 in that it includes a transceiver 21 and a transceiver 22 that are separated from each other.

The transceiver 21 includes a frequency control unit 21a that receives return signal light that is a light wave indicated by an arrow Y2 which will be described later, in addition to having the same functions as the frequency control unit 12e of the transmitter 11 (of FIG. 1) described above. The transceiver 21 will also be referred to as a reference transceiver 21 because a reference signal source 14 is connected to the transceiver 21.

The transceiver 22 includes splitters 12b to 12d, mirrors 12f and 12g, a spatial filtering unit 12h, and a wavefront measurement unit 12i, similar to the receiver 12 (of FIG. 1) described above, and also includes a spatial light modulation unit 22a and a frequency control unit 22e. The frequency control units 21a and 22e perform control for correcting frequency fluctuations.

The frequency control unit 22e includes an acousto optic modulator (AOM) unit 22j in addition to having the functions of the frequency control unit 12e (of FIG. 1) described above. The AOM unit 22j reflects reference signal light transmitted through the splitter 12b to return it as signal light of a frequency f2 to which the frequency f1 of the reference signal light has been slightly shifted. Then, a process for transmitting the return signal light from the receiver 12 back to the transmitter 11 via the space 15 as indicated by an arrow Y2 is performed. The return signal light can be distinguished from the reference signal light because the return signal light has a different frequency f2 to which the frequency f1 of the reference signal light has been slightly shifted.

The spatial light modulation unit 22a wavefront-modulates the reference signal light of the frequency f1 indicated by the arrow Y1 with the reversed wavefront distortion described above in the same manner as the spatial light modulation unit 12a (of FIG. 1) described above and wavefront-modulates the return signal light indicated by the arrow Y2 at the same timing and in the same manner.

In this system 20, wavefront correction of the reference signal light is performed as follows using a digital optical phase conjugation (DOPC) technique (see NPL 2).

That is, in the transceiver 22, the wavefront measurement unit 12i measures a wavefront distortion of a light wave (reference signal light of the arrow Y1) transmitted through an atmospheric fluctuation 15a that applies the wavefront distortion. After that, the spatial light modulation unit 22a wavefront-modulates return signal light, which is signal light of a plane wave propagating in the opposite direction indicated by the arrow Y2, with a reversed wavefront distortion.

In this wavefront modulation, the return signal light of a plane wave is wavefront-modulated with the reversed wavefront distortion, such that a wavefront distortion opposite to that applied during transmission through the atmospheric fluctuation 15a is applied to the return signal light. Thus, when the wavefront-modulated return signal light (of arrow Y2) passes through the atmospheric fluctuation 15a and is received by the frequency control unit 21a of the transceiver 21, the wavefront distortion due to the atmospheric fluctuation 15 cancels out the opposite wavefront distortion due to the wavefront modulation, such that the return signal light becomes signal light of a plane wave. This process is wavefront correction by DOPC.

### Operation of Second Embodiment

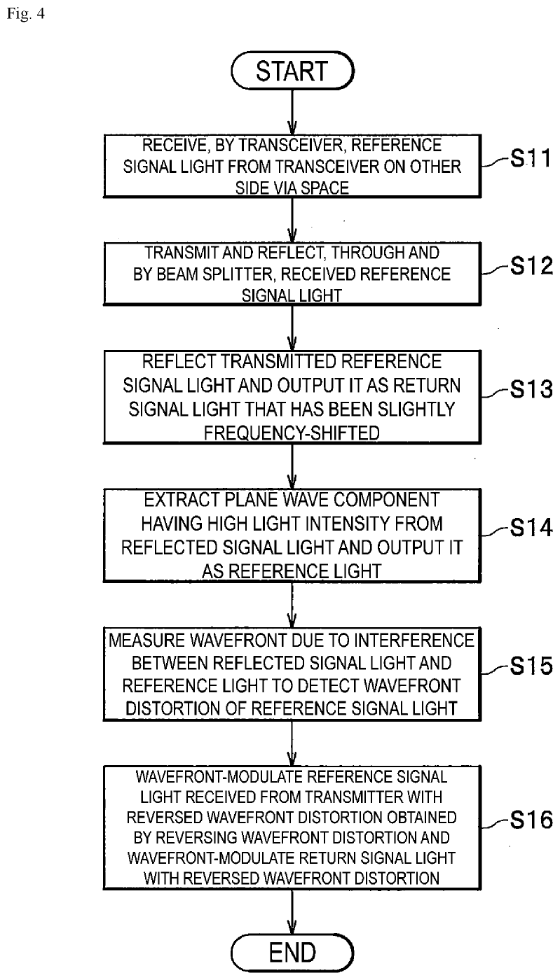

Next, an operation of the system 20 according to the second embodiment will be described with reference to a flowchart shown in FIG. 4.

First, reference signal light output from the reference signal source 14 is output to the transceiver 21 via the optical fiber 13a.

Next, in step S1l shown in FIG. 4, the reference signal light input to the transceiver 21 is transmitted to the space 15 via the frequency control unit 21a as indicated by the arrow Y1 and then received by the transceiver 22. Here, it is assumed that a wavefront distortion that is an altered wavefront of light is caused to the reference signal light due to the influence of the atmospheric fluctuation 15a shown as a dashed pulse during transmission through the space 15.

In step S12, the reference signal light received by the transceiver 22 is transmitted through and reflected by the splitter 12b via the spatial light modulation unit 22a. The transmitted reference signal light is incident on the frequency control unit 22e and the reflected reference signal light is further reflected by the splitter 12c, further reflected by the mirror 12f, and input to the spatial filtering unit 12h.

In step S13, the frequency control unit 22e reflects the input reference signal light by the AOM unit 22j to return it as signal light of a frequency f2 that has been slightly frequency-shifted. The return signal light is input to the spatial light modulation unit 22a via the splitter 12b.

In step S14, the spatial filtering unit 12h extracts a plane wave component having a high light intensity from the input signal light and outputs the extracted plane wave component to the mirror 12f as reference light. This reference light is reflected by the mirror 12f and the splitter 12d and input to the wavefront measurement unit 12i.

On the other hand, the reference signal light reflected by the splitter 12b is transmitted through the splitters 12c and 12d and input to the wavefront measurement unit 12i.

In step S15, the wavefront measurement unit 12i measures a wavefront due to the interference between the input signal light and the reference light to detect a wavefront distortion of the reference signal light and outputs the detected wavefront distortion to the spatial light modulation unit 12a.

In step S16, the reference signal light of the frequency f1 indicated by the arrow Y1 is wavefront-modulated with the reversed wavefront distortion described above in the same manner as in the spatial light modulation unit 12a (of FIG. 1) and the return signal light indicated by the arrow Y2 is wavefront-modulated at the same timing and in the same manner.

By this wavefront modulation, the reference signal light is corrected to a plane wave without wavefront distortions. The corrected reference signal light is transmitted through the splitter 12b and output to the frequency control unit 12e. By the same wavefront modulation, the return signal light of a plane wave is wavefront-modulated with the reversed wavefront distortion, such that the return signal light to which a wavefront distortion opposite to that applied during transmission through the atmospheric fluctuation 15a has been applied is transmitted back to the space 15.

### Advantages of Second Embodiment

The transceiver 22 at the other side which is separated from the reference transceiver (transceiver) 21 in the system 20 of the second embodiment includes at least the spatial light modulation unit 22a, the splitters 12b, 12c, and 12d, the frequency control unit 22e, the spatial filtering unit 12h, and the wavefront measurement unit 12i.

The splitters 12b to 12d transmit and reflect the reference signal light of the reference optical frequency received via the space 15 after being transmitted from the reference transceiver 21. The frequency control unit 22e couples the transmitted reference signal light to the optical fiber 13b to transmit the reference signal light and frequency-shifts and returns the reference signal light and transmits the return signal light back to the reference transceiver 21.

The spatial filtering unit 12h extracts a plane wave component which is a signal component other than distortions from the reflected light that has been reflected by the splitters 12b and 12c and outputs the extracted light as reference light indicated by a dashed arrow. The wavefront measurement unit 12i measures a wavefront due to the interference between the reference light and the signal light reflected and transmitted by the splitters 12b to 12d to detect a wavefront distortion of the reference signal light.

The spatial light modulation unit 22a wavefront-modulates the reference signal light received from the reference transceiver 21 into a plane wave without wavefront distortions with a reversed wavefront distortion obtained by reversing the wavefront distortion and wavefront-modulates the return signal light with the reversed wavefront distortion.

According to this configuration, the reference signal light on an outward path from the transceiver 21 to the transceiver 22 on the other side and the return signal light on a return path opposite to the outward path are wavefront-modulated with the reversed wavefront distortion at the same timing and in the same manner. The reference signal light is wavefront-modulated with a reversed wavefront distortion obtained by reversing the wavefront distortion, such that the reference signal light is corrected to a plane wave without wavefront distortions.

Further, when the wavefront-modulated return signal light passes through the atmospheric fluctuation 15a in the space 15 and is received by the transceiver 21, the wavefront distortion due to the atmospheric fluctuation 15a cancels out the opposite wavefront distortion due to the wavefront modulation, such that the return signal light becomes signal light of a plane wave. That is, because the wavefront modulation automatically produces phase conjugation between the reference signal light and the return signal light, wavefront distortions of both the reference signal light and the return signal light can be corrected and the light intensity can be stabilized by the correction.

Such a system 20 may perform a process described below.

At the initial (first) timing, the wavefront measurement unit 12i detects a wavefront distortion of the reference signal light and the spatial light modulation unit 12a wavefront-modulates the reference signal light with a reversed wavefront distortion obtained by reversing the wavefront distortion as described above. At each subsequent timing (each of the second and subsequent timings), when currently received reference signal light passes through the spatial light modulation unit 12a, a wavefront distortion is caused to the current reference signal light in a wavefront portion other than a plane wave portion of the reference signal light which has been corrected to a plane wave with the previous wavefront modulation. That is, the spatial light modulation unit 12a outputs the difference between the wavefronts of the previous reference signal light and the current reference signal light as a wavefront distortion.

Therefore, at the current timing, the wavefront measurement unit 12i detects the difference and the spatial light modulation unit 12a performs a process of correcting the reference signal light by wavefront-modulating the reference signal light with a reversed wavefront distortion obtained by reversing the detected difference. The same process is performed at each subsequent timing.

For example, the spatial light modulation unit 12a outputs the wavefront difference (wavefront distortion) between the reference signal light corrected by the wavefront modulation at the first timing and the reference signal light received at the second timing. Therefore, at the second timing, the wavefront measurement unit 12i detects the difference and the spatial light modulation unit 12a corrects the reference signal light by wavefront-modulating the reference signal light with a reversed wavefront distortion obtained by reversing the detected difference.

That is, at each of the second and subsequent timings, the difference (wavefront distortion) between the reference signal light of the previous and current timings is detected to perform correction through wavefront modulation, such that the amount of correction (the amount of wavefront distortion) is reduced.

Thus, because the wavefront distortion of the reference signal light is reduced, the intensity of reference light that the spatial filtering unit 12h obtains from the reference signal light becomes stronger and the wavefront measurement unit 12i can perform wavefront measurement more suitably.

In addition, the interval of feedback in the transceiver 22 involving reception of the reference signal light, measurement of the wavefront, and wavefront modulation of both the reference signal light and the return signal light is determined as follows. That is, the interval (period such as 1s) until the next wavefront measurement in the feedback is determined by the refresh rate of the wavefront measurement unit 12i implemented by a camera or the like or a response speed for wavefront modulation of the spatial light modulation unit 12a.

Here, in the present system 20, the amount of correction (the amount of wavefront distortion) is reduced as described above, such that the amount of processing of a feedback loop for wavefront modulation is reduced and the feedback interval can be shortened accordingly.

### First Modification of Second Embodiment

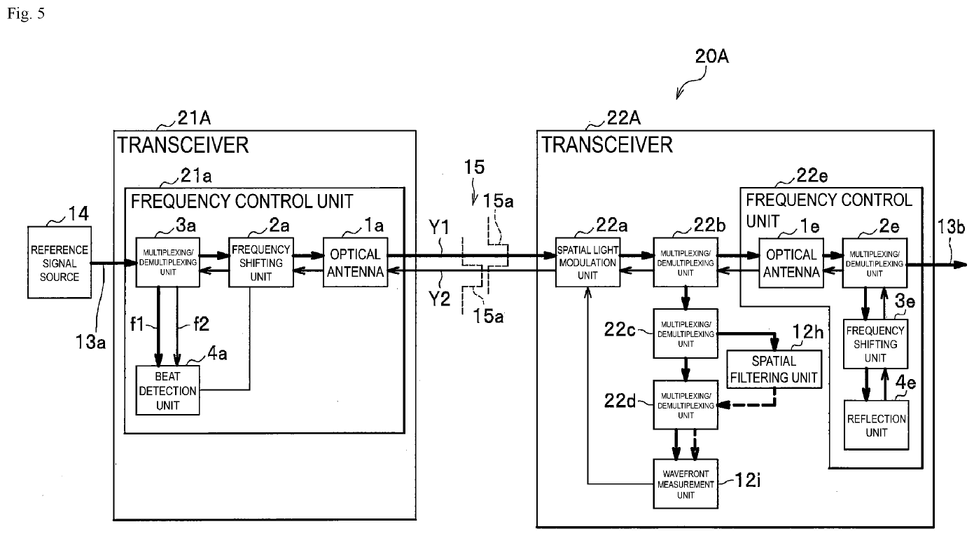

FIG. 5 is a block diagram illustrating a configuration of a spatial light frequency transmission system according to a first modification of the second embodiment of the present invention.

The difference of a system 20A of the first modification illustrated in FIG. 5 from the system 20 (of FIG. 3) is that a transceiver 21A and a transceiver 22A are configured as follows.

A frequency control unit 21a of the transceiver 21A is configured to include an optical antenna 1a, a frequency shifting unit 2a, a multiplexing/demultiplexing unit 3a, and a beat detection unit 4a. The optical antenna 1a, the frequency shifting unit 2a, the multiplexing/demultiplexing unit 3a, and the beat detection unit 4a are bidirectionally connected by optical fibers. However, a frequency difference output end of the beat detection unit 4a which will be described later and a control end of the frequency shifting unit 2a are connected by an electric signal line. Each multiplexing/demultiplexing unit forms a beam splitter in the claims.

The transceiver 22A is configured to include multiplexing/demultiplexing units 22b, 22c, and 22d corresponding to the splitters 12b, 12c, and 12d (of FIG. 3) described above, a spatial filtering unit 12h, a wavefront measurement unit 12i, and a spatial light modulation unit 22a. A frequency control unit 22e is configured to include an optical antenna 1e, a multiplexing/demultiplexing unit 2e, a frequency shifting unit 3e, and a reflection unit 4e.

The optical antenna 1e, the multiplexing/demultiplexing unit 2e, the frequency shifting unit 3e, and the reflection unit 4e are bidirectionally connected by optical fibers and another end of the multiplexing/demultiplexing unit 2e is connected to an optical fiber 13b which is a transmission line. The optical antenna 1e, the multiplexing/demultiplexing unit 22b, and the spatial light modulation unit 22a are connected by signal light propagating through space.

The multiplexing/demultiplexing units 22b to 22d are connected to the wavefront measurement unit 12i by optical fibers such that the multiplexing/demultiplexing unit 22b is connected to the wavefront measurement unit 12i via the multiplexing/demultiplexing units 22c and 22d, and the multiplexing/demultiplexing units 22c and 22d are connected by an optical fiber via the spatial filtering unit 12h. However, a measurement result output end of the wavefront measurement unit 12i and a control end of the spatial light modulation unit 22a are connected by an electric signal line.

In the transceiver 21A, the multiplexing/demultiplexing unit 3a splits reference signal light of a frequency f1 from a reference signal source 14 into the frequency shifting unit 2a and the beat detection unit 4a. Further, the multiplexing/demultiplexing unit 3a demultiplexes return signal light of a frequency f2 received from the transceiver 22A on the other side via the optical antenna 1a and the frequency shifting unit 2a and outputs the demultiplexed light to the beat detection unit 4a.

The beat detection unit 4a obtains the frequency difference (beat frequency) between the frequency f1 of the reference signal light and the frequency f2 of the return signal light and outputs the frequency difference to the frequency shifting unit 2a via an electric signal line.

The frequency shifting unit 2a frequency-shifts the return signal light from the optical antenna 1a such that the frequency difference from the beat detection unit 4a becomes a constant frequency (for example, 10 MHz). The frequency difference is made constant by repeating the feedback in which the frequency-shifted return signal light is input to the beat detection unit 4a via the multiplexing/demultiplexing unit 3a.

When the reference signal light is frequency-shifted by the frequency shifting unit 2a controlled as described above, the frequency of the reference signal light finally output from the optical fiber 13b becomes constant.

The optical antenna 1a transmits the reference signal light to the transceiver 22A on the other side via the space 15 as indicated by an arrow Y1 and receives return signal light indicated by an arrow Y2 from the transceiver 22A on the other side via the space 15.

In the transceiver 22A, the optical antenna 1e couples reference signal light, which has been received via the spatial light modulation unit 22a and the multiplexing/demultiplexing unit 22b, to the optical fiber 13b via the multiplexing/demultiplexing unit 2e. Further, the optical antenna 1e transmits return signal light, which has been input from the reflection unit 4e via the frequency shifting unit 3e and the multiplexing/demultiplexing unit 2e, via the multiplexing/demultiplexing unit 22b and the spatial light modulation unit 22a.

The reflection unit 4e reflects the reference signal light, which has been output from the optical antenna 1e and demultiplexed by the multiplexing/demultiplexing unit 2e, to the frequency shifting unit 3e.

The frequency shifting unit 3e frequency-shifts the return signal light such that the frequency difference from the reference signal light is constant (for example, at 10 MHz) and outputs the frequency-shifted return signal light to the multiplexing/demultiplexing unit 2e. The multiplexing/demultiplexing unit 2e outputs the return signal light to the optical antenna 1e. This return signal light is transmitted to the space 15 via the multiplexing/demultiplexing unit 22b and the spatial light modulation unit 22a.

The multiplexing/demultiplexing unit 22b demultiplexes the reference signal light received via the spatial light modulation unit 22a into the optical antenna 1e and the multiplexing/demultiplexing unit 22c. The multiplexing/demultiplexing unit 22c demultiplexes the demultiplexed reference signal light into the spatial filtering unit 12h and the multiplexing/demultiplexing unit 22d. The multiplexing/demultiplexing unit 22d inputs the reference light from the spatial filtering unit 12h described above and the reference signal light from the multiplexing/demultiplexing unit 22c to the wavefront measurement unit 12i.

### Operation of First Modification of Second Embodiment

Next, an operation of the system 20A of the first modification will be described.

Reference signal light output from the reference signal source 14 is input to the transceiver 21A via the optical fiber 13a. The input reference signal light is transmitted from the optical antenna 1a to the space 15 as indicated by the arrow Y1 via the multiplexing/demultiplexing unit 3a and the frequency shifting unit 2a and is received by the transceiver 22A on the other side. Here, it is assumed that a wavefront distortion that is an altered wavefront of light is caused to the reference signal light due to the influence of the atmospheric fluctuation 15a.

The reference signal light received by the transceiver 22A is demultiplexed into the optical antenna 1e and the multiplexing/demultiplexing unit 22c by the multiplexing/demultiplexing unit 22b via the spatial light modulation unit 22a. The reference signal light demultiplexed into the optical antenna 1e is coupled to the optical fiber 13b from the optical antenna 1e via the multiplexing/demultiplexing unit 2e and is also demultiplexed by the multiplexing/demultiplexing unit 2e and reflected by the reflection unit 4e via the frequency shifting unit 3e.

The reflected return signal light is frequency-shifted by the frequency shifting unit 3e such that it has a constant frequency difference (for example, of 10 MHz) from the frequency of the reference signal light and is output to the optical antenna 1e via the multiplexing/demultiplexing unit 2e. The output return signal light is transmitted from the optical antenna 1e to the space 15 via the multiplexing/demultiplexing unit 22b and the spatial light modulation unit 22a. Here, it is assumed that a wavefront distortion that is an altered wavefront of light is caused to the return signal light due to the influence of the atmospheric fluctuation 15a.

On the other hand, the reference signal light demultiplexed by the multiplexing/demultiplexing unit 22b of the transceiver 22A is demultiplexed by the multiplexing/demultiplexing unit 22c and one of the demultiplexed reference signal beams is converted into reference light by the spatial filtering unit 12h. This reference light is input to the wavefront measurement unit 12i via the multiplexing/demultiplexing unit 22d. The reference signal light demultiplexed by the multiplexing/demultiplexing unit 22c is also input to the wavefront measurement unit 12i via the multiplexing/demultiplexing unit 22d.

The wavefront measurement unit 12i measures a wavefront due to the interference between the input reference signal light and the reference light to detect a wavefront distortion of the reference signal light and outputs the detected wavefront distortion to the spatial light modulation unit 22a.

The spatial light modulation unit 22a wavefront-modulates the received reference signal light with a reversed wavefront distortion obtained by reversing the wavefront distortion and wavefront-modulates the return signal light with the reversed wavefront distortion. These wavefront modulations correct the wavefront distortion of the reference signal light due to the atmospheric fluctuation 15.

The return signal light is also a plane wave because it is obtained by reflecting the corrected reference signal light. Because this return signal light of a plane wave is wavefront-modulated with the reversed wavefront distortion, a wavefront distortion opposite to that due to the atmospheric fluctuation 15a is applied to the return signal light. Thus, when the return signal light passes through the atmospheric fluctuation 15a and is received by the optical antenna 1a of the transceiver 21A, the wavefront distortion due to the atmospheric fluctuation 15 cancels out the opposite wavefront distortion due to the wavefront modulation, such that the return signal light becomes signal light of a plane wave.

The return signal light received by the optical antenna 1a is input to the beat detection unit 4a via the frequency shifting unit 2a and the multiplexing/demultiplexing unit 3a. At this time, the reference signal light is also input to the beat detection unit 4a.

The beat detection unit 4a obtains the frequency difference between the reference signal light and the return signal light and outputs the frequency difference to the frequency shifting unit 2a. The frequency shifting unit 2a frequency-shifts the return signal light such that the frequency difference becomes a constant frequency (for example, 10 MHz). This frequency shift control makes the frequency difference between the reference signal light and the return signal light constant.

### Advantages of First Modification of Second Embodiment

In the system 20A of the present first modification, the transceiver 21A can make the frequency difference between the return signal light received from the transceiver 22A on the other side and the reference signal light transmitted to the transceiver 22A on the other side constant, such that it is possible to properly discriminate between the reference signal light and the return signal light.

### Second Modification of Second Embodiment

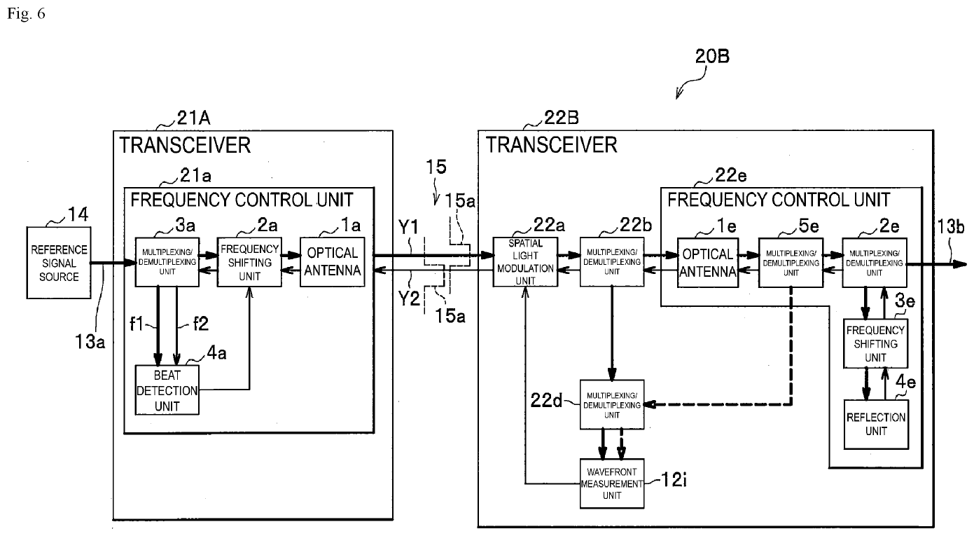

FIG. 6 is a block diagram illustrating a configuration of a spatial light frequency transmission system according to a second modification of the second embodiment of the present invention.

The following is the difference of a system 20B of the second modification illustrated in FIG. 6 from the system 20A (of FIG. 5) of the first modification. That is, the difference is that a frequency control unit 22e of a transceiver 22B includes a multiplexing/demultiplexing unit 5e between the optical antenna 1e and the multiplexing/demultiplexing unit 2e and reference light indicated by a dashed arrow which will be described later is output from the multiplexing/demultiplexing unit 5e and input to the wavefront measurement unit 12i via the multiplexing/demultiplexing unit 22d.

The transceiver 22B having this configuration does not require the multiplexing/demultiplexing unit 22c and the spatial filtering unit 12h that are provided in the transceiver 22A of the first modification illustrated in FIG. 5.

Returning to FIG. 6, the optical antenna 1e focuses and couples the received reference signal light to the optical fiber 13b by a lens (not shown). The multiplexing/demultiplexing unit 5e demultiplexes the focused reference signal light and inputs the demultiplexed light to the wavefront measurement unit 12i as reference light via the multiplexing/demultiplexing unit 22d.

### Advantages of Second Modification of Second Embodiment

Because the reference signal light focused as described above is demultiplexed and used as reference light, the light intensity of the reference light is increased. Because the wavefront measurement unit 12i detects a wavefront distortion of the reference signal light using the reference light having a high light intensity, it is possible to properly detect the wavefront distortion.

In the system 20B, the transceiver 22B is configured such that, when the frequency control unit 22e has focused the received reference signal light to couple it to the optical fiber 13b, the multiplexing/demultiplexing unit 5e demultiplexes the focused reference signal light and inputs the demultiplexed light to the wavefront measurement unit 12i as reference light via the multiplexing/demultiplexing unit 22d.

According to this configuration, the spatial filtering unit 12h (of FIG. 5) of the second embodiment for obtaining reference light from the reference signal light is unnecessary, such that the size of the transceiver 22B can be reduced.

### Configuration of Third Embodiment

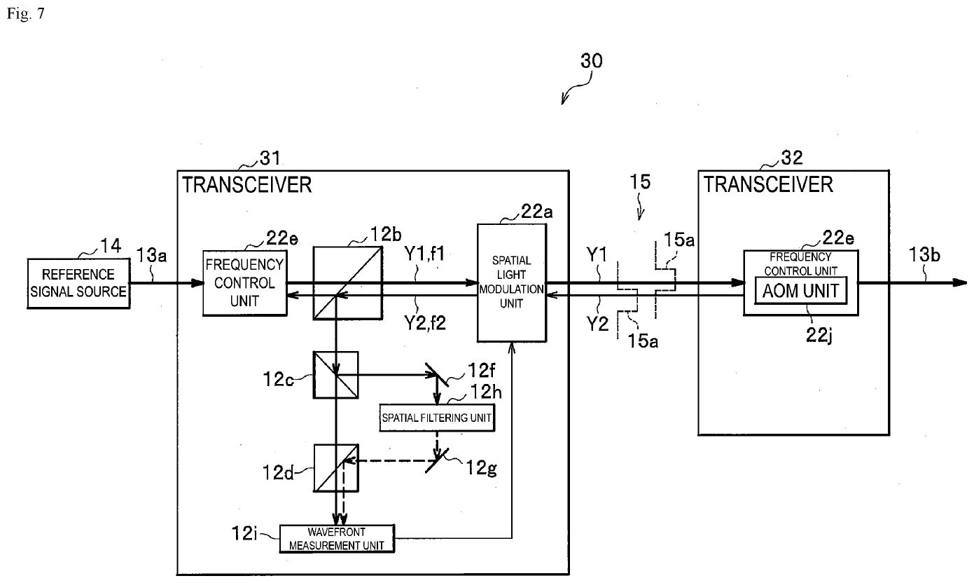

FIG. 7 is a block diagram illustrating a configuration of a spatial light frequency transmission system according to a third embodiment of the present invention.

A system 30 of the third embodiment illustrated in FIG. 7 differs from the system 20 of the second embodiment in that a transceiver 31 having an internal frequency control unit 22e connected to an external reference signal source 14 includes the splitters 12b to 12d, the mirrors 12f and 12g, the spatial filtering unit 12h, the wavefront measurement unit 12i, and the spatial light modulation unit 22a described above. A transceiver 32 that is separated from the transceiver 31 includes a frequency control unit 22e having an AOM unit 22j.

In this system 30, when reference signal light that has been transmitted from the reference signal source 14 to the optical fiber 13a is transmitted to space 15 as indicated by an arrow Y1 via the spatial light modulation unit 22a of the transceiver 31, the reference signal light is received by the transceiver 32. The received reference signal light is returned by the AOM unit 22j as indicated by an arrow Y2 and the return signal light is received by the transceiver 31 via the space 15.

The return signal light received by the transceiver 31 is transmitted through and reflected by the splitter 12b via the spatial light modulation unit 12a. The reflected return signal light is further reflected by the splitter 12c, further reflected by the mirror 12f, and input to the spatial filtering unit 12h.

The spatial filtering unit 12h extracts a plane wave component having a high light intensity from the input return signal light and outputs the extracted plane wave component to the mirror 12f as reference light. This reference light is reflected by the mirror 12f and the splitter 12d and input to the wavefront measurement unit 12i.

On the other hand, the return signal light reflected by the splitter 12b is transmitted through the splitters 12c and 12d and input to the wavefront measurement unit 12i.

The wavefront measurement unit 12i measures a wavefront due to the interference between the input return signal light and the reference light to detect a wavefront distortion of the return signal light and outputs the detected wavefront distortion to the spatial light modulation unit 12a.

The spatial light modulation unit 22a wavefront-modulates the reference signal light indicated by the arrow Y1 with a reversed wavefront distortion obtained by reversing the wavefront distortion from the spatial light modulation unit 22a and wavefront-modulates the return signal light indicated by the arrow Y2 at the same timing and in the same manner. At this time, the atmospheric fluctuation 15a causes a wavefront distortion to the return signal light. However, because the return signal light is wavefront-modulated with a reversed wavefront distortion obtained by reversing the wavefront distortion, the return signal light is corrected to a plane wave without wavefront distortions. The corrected return signal light is transmitted through the splitter 12b and output to the frequency control unit 21a.

On the other hand, because the reference signal light indicated by the arrow Y1 is wavefront-modulated with the reversed wavefront distortion, a wavefront distortion opposite to that applied during transmission through the atmospheric fluctuation 15a is applied to the reference signal light. Thus, when the wavefront-modulated reference signal light (of the arrow Y1) passes through the atmospheric fluctuation 15a and is received by the frequency control unit 22e of the transceiver 32, the wavefront distortion due to the atmospheric fluctuation 15 cancels out the opposite wavefront distortion due to the wavefront modulation, such that the reference signal light becomes signal light of a plane wave.

### Advantages of Third Embodiment

That is, because the wavefront modulation automatically produces phase conjugation between the reference signal light and the return signal light, wavefront distortions of both the reference signal light and the return signal light can be corrected and the light intensity can be stabilized by the correction.

### First Modification of Third Embodiment

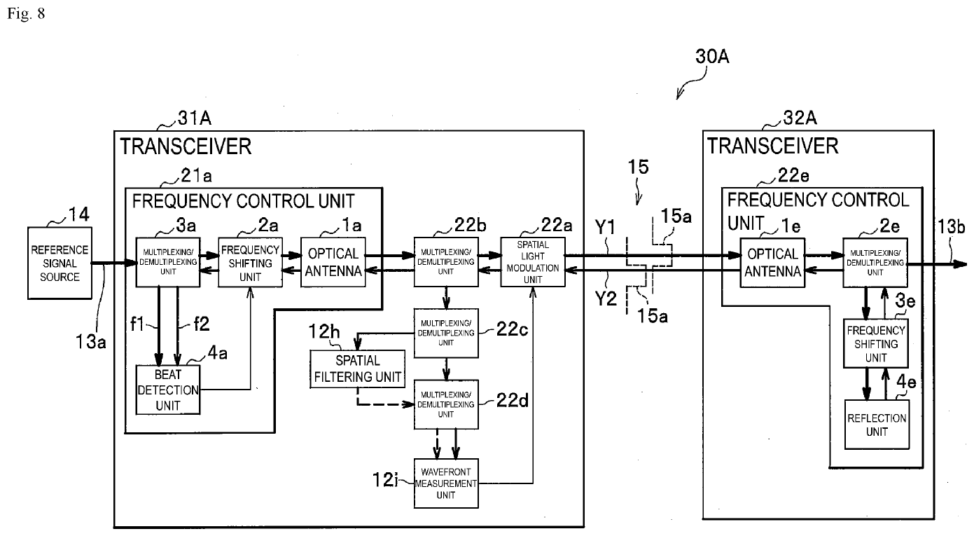

FIG. 8 is a block diagram illustrating a configuration of a spatial light frequency transmission system according to a first modification of the third embodiment of the present invention.

The difference of a system 30A of the first modification illustrated in FIG. 8 from the system 30 (of FIG. 7) is that a transceiver 31A and a transceiver 32A are configured as follows.

The transceiver 31A is configured to include multiplexing/demultiplexing units 22b, 22c, and 22d corresponding to the splitters 12b, 12c, and 12d (of FIG. 3) described above, a spatial filtering unit 12h, a wavefront measurement unit 12i, and a spatial light modulation unit 22a. Further, a frequency control unit 21a is configured to include the optical antenna 1a, the frequency shifting unit 2a, the multiplexing/demultiplexing unit 3a, and the beat detection unit 4a that have been described with reference to FIG. 5. However, in a feedback loop involving the multiplexing/demultiplexing units 22b, 22c, and 22d, the spatial filtering unit 12h, the wavefront measurement unit 12i, and the spatial light modulation unit 22a, return signal light is processed as will be described later.

A frequency control unit 22e of the transceiver 32A is configured to include the optical antenna 1e, the multiplexing/demultiplexing unit 2e, the frequency shifting unit 3e, and the reflection unit 4e that have been described with reference to FIG. 5.

In the system 30A illustrated in FIG. 8, reference signal light output from the reference signal source 14 is input to the transceiver 31A via the optical fiber 13a. After passing through the multiplexing/demultiplexing unit 3a and the frequency shifting unit 2a, the input reference signal light is transmitted from the optical antenna 1a to the space 15 as indicated by the arrow Y1 via the multiplexing/demultiplexing unit 22b and the spatial light modulation unit 22a and is received by the transceiver 32A on the other side. Here, it is assumed that a wavefront distortion that is an altered wavefront of light is caused to the reference signal light due to the influence of the atmospheric fluctuation 15a.

The reference signal light received by the transceiver 32A is coupled to the optical fiber 13b from the optical antenna 1e via the multiplexing/demultiplexing unit 2e and is also demultiplexed by the multiplexing/demultiplexing unit 2e and reflected by the reflection unit 4e via the frequency shifting unit 3e.

The reflected return signal light is frequency-shifted by the frequency shifting unit 3e such that it has a constant frequency difference (for example, of 10 MHz) from the frequency of the reference signal light and is output to the optical antenna 1e via the multiplexing/demultiplexing unit 2e. The output return signal light is transmitted from the optical antenna 1e to the space 15 as indicated by the arrow Y2. Here, it is assumed that a wavefront distortion that is an altered wavefront of light is caused to the return signal light due to the influence of the atmospheric fluctuation 15a.

The return signal light is received by the transceiver 31A and is demultiplexed into the optical antenna 1a and the multiplexing/demultiplexing unit 22c by the multiplexing/demultiplexing unit 22b via the spatial light modulation unit 22a. The demultiplexed return signal light is further demultiplexed by the multiplexing/demultiplexing unit 22c into the spatial filtering unit 12h and the multiplexing/demultiplexing unit 22d. The spatial filtering unit 12h converts the return signal light into reference light, which is input to the wavefront measurement unit 12i. The return signal light demultiplexed by the multiplexing/demultiplexing unit 22d is also input to the wavefront measurement unit 12i.

The wavefront measurement unit 12i measures a wavefront due to the interference between the input return signal light and the reference light to detect a wavefront distortion of the return signal light and outputs the detected wavefront distortion to the spatial light modulation unit 22a.

The spatial light modulation unit 22a wavefront-modulates the received return signal light (of the arrow Y2) with a reversed wavefront distortion obtained by reversing the wavefront distortion and wavefront-modulates the reference signal light (of the arrow Y1) with the reversed wavefront distortion. At this time, the atmospheric fluctuation 15a causes a wavefront distortion to the return signal light. However, because the return signal light is wavefront-modulated with a reversed wavefront distortion obtained by reversing the wavefront distortion, the return signal light is corrected to a plane wave without wavefront distortions. The corrected return signal light is output to the frequency control unit 21a via the multiplexing/demultiplexing unit 22b.

On the other hand, because the spatial light modulation unit 22a wavefront-modulates the reference signal light which is a plane wave with the reversed wavefront distortion, a wavefront distortion opposite to that due to the atmospheric fluctuation 15a is applied to the reference signal light. Thus, when the wavefront-modulated reference signal light passes through the atmospheric fluctuation 15a and is received by the transceiver 32A, the wavefront distortion due to the atmospheric fluctuation 15 cancels out the opposite wavefront distortion due to the wavefront modulation, such that the reference signal light becomes signal light of a plane wave.

In the transceiver 31A, the return signal light input to the optical antenna 1a of the frequency control unit 21a is input to the beat detection unit 4a via the frequency shifting unit 2a and the multiplexing/demultiplexing unit 3a. At this time, the reference signal light is also input to the beat detection unit 4a.

The beat detection unit 4a obtains the frequency difference between the reference signal light of the frequency f1 and the return signal light of the frequency f2 and outputs the frequency difference to the frequency shifting unit 2a. The frequency shifting unit 2a frequency-shifts the return signal light such that the frequency difference becomes a constant frequency (for example, 10 MHz). This frequency shift control makes the frequency difference between the reference signal light and the return signal light constant.

### Advantages of First Modification of Third Embodiment

In the system 30A of the present first modification, the transceiver 31A can make the frequency difference between the return signal light received from the transceiver 32A on the other side and the reference signal light transmitted to the transceiver 32A on the other side constant, such that it is possible to properly discriminate between the reference signal light and the return signal light.

### Second Modification of Third Embodiment

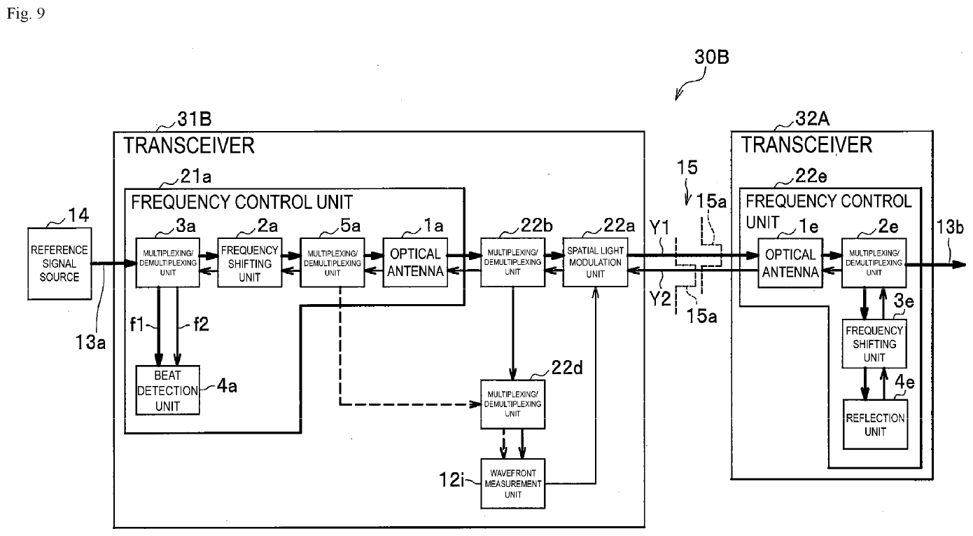

FIG. 9 is a block diagram illustrating a configuration of a spatial light frequency transmission system according to a second modification of the second embodiment of the present invention.

The following is the difference of a system 30B of the second modification illustrated in FIG. 9 from the system 30A (of FIG. 8) of the first modification of the third embodiment described above. That is, the difference is that a frequency control unit 21a of a transceiver 31B includes a multiplexing/demultiplexing unit 5a between the optical antenna 1a and the frequency shifting unit 2a and reference light indicated by a dashed arrow which will be described later is output from the multiplexing/demultiplexing unit 5a and input to the wavefront measurement unit 12i via the multiplexing/demultiplexing unit 22d.

The transceiver 31B having this configuration does not require the multiplexing/demultiplexing unit 22c and the spatial filtering unit 12h that are provided in the transceiver 31A of the first modification illustrated in FIG. 8.

Returning to FIG. 9, the optical antenna 1a focuses and couples the received reference signal light to an optical fiber (not shown) by a lens (not shown). The multiplexing/demultiplexing unit 5a demultiplexes the focused return signal light and inputs the demultiplexed light to the wavefront measurement unit 12i as reference light via the multiplexing/demultiplexing unit 22d.

### Advantages of Second Modification of Second Embodiment

Because the return signal light focused as described above is demultiplexed and used as reference light, the light intensity of the reference light is increased. Because the wavefront measurement unit 12i detects a wavefront distortion of the return signal light using the reference light having a high light intensity, it is possible to properly detect the wavefront distortion.

The system 30B is configured such that, when the frequency control unit 21a has focused the received return signal light for coupling to an optical fiber (not shown), the focused return signal light is demultiplexed and the demultiplexed light is input to the wavefront measurement unit 12i as reference light.

According to this configuration, the spatial filtering unit 12h (of FIG. 8) for obtaining reference light from the return signal light is unnecessary, such that the size of the transceiver 31B can be reduced.

### Advantages

(1) A receiver includes a beam splitter that transmits and reflects reference signal light of a reference optical frequency received from a transmitter via space, a spatial filtering unit that extracts a plane wave component other than distortions from the reference signal light reflected by the beam splitter and outputs extracted light as reference light, a wavefront measurement unit that measures a wavefront due to an interference between the reference light and the reference signal light reflected by the beam splitter to detect a wavefront distortion of the reference signal light, and a spatial light modulation unit that wavefront-modulates the reference signal light received from the transmitter into a plane wave without wavefront distortions with a reversed wavefront distortion obtained by reversing the wavefront distortion.

According to this configuration, the spatial filtering unit can extract a plane wave component other than distortions from the reference signal light received by the receiver. Because the plane wave component has a high light intensity, it is possible to prevent deterioration of the wavefront measurement accuracy of the wavefront measurement unit and the spatial light modulation unit can accurately correct wavefront distortions. In other words, it is possible to accurately correct wavefront distortions caused when reference signal light which is a light wave of the reference frequency is transmitted through the space.

(2) A transceiver includes a beam splitter that transmit and reflect reference signal light of a reference optical frequency received via space after being transmitted from a transceiver on another side, a frequency control unit that couples the transmitted reference signal light to an optical fiber to transmit the reference signal light, frequency-shifts and returns the reference signal light, and transmits return signal light back to the transceiver, a spatial filtering unit that extracts a plane wave component other than distortions from the reference signal light reflected by the beam splitter and outputs extracted light as reference light, a wavefront measurement unit that measures a wavefront due to an interference between the reference light and the reference signal light reflected by the beam splitter to detect a wavefront distortion of the reference signal light, and a spatial light modulation unit that wavefront-modulates the reference signal light received from the transceiver into a plane wave without wavefront distortions with a reversed wavefront distortion obtained by reversing the wavefront distortion and wavefront-modulates the return signal light with the reversed wavefront distortion.

According to this configuration, the reference signal light on an outward path from the transceiver on the other side to the transceiver and the return signal light on a return path opposite to the outward path are wavefront-modulated with the reversed wavefront distortion at the same timing and in the same manner. When the return signal light that the spatial light modulation unit has wavefront-modulated with the reversed wavefront distortion passes through an atmospheric fluctuation in the space and is received by the transceiver, the wavefront distortion due to the atmospheric fluctuation cancels out the opposite wavefront distortion due to the wavefront modulation, such that the return signal light becomes signal light of a plane wave. That is, because the wavefront modulation automatically produces phase conjugation between the reference signal light and the return signal light, wavefront distortions of both the reference signal light and the return signal light can be corrected and the light intensity can be stabilized by the correction.

(3) In the transceiver according to the above (2), the spatial light modulation unit outputs, at next and subsequent timings after wavefront modulation of the reference signal light is performed at an initial timing, a wavefront distortion caused to reference signal light received at a current timing in a wavefront portion other than a plane wave portion of reference signal light that is corrected to a plane wave through wavefront modulation at a previous timing as a difference between current reference signal light and previous reference signal light, the wavefront measurement unit detects the difference, and the spatial light modulation unit performs wavefront modulation of the current reference signal light with a reversed wavefront distortion obtained by reversing the detected difference.

According to this configuration, at each subsequent timing, the wavefront measurement unit detects the difference between the second reference signal light and the previous (first) reference signal light at the current timing (for example, the second timing) and the spatial light modulation unit wavefront-modulates the reference signal light with the reversed wavefront distortion obtained by reversing the detected difference. This corrects wavefront distortions of the second reference signal light. That is, at each of the second and subsequent timings, the difference (wavefront distortion) between the reference signal light of the previous and current timings is detected to perform correction through wavefront modulation, such that the amount of correction (the amount of wavefront distortion) is reduced. Thus, because the wavefront distortion of the reference signal light is reduced, the intensity of reference light that the spatial filtering unit obtains from the reference signal light becomes stronger and the wavefront measurement unit can perform wavefront measurement more suitably.

Further, because the amount of correction (the amount of wavefront distortion) is reduced as described above, the amount of processing for feedback in the transceiver involving reception of the reference signal light, measurement of the wavefront, and wavefront modulation of both the reference signal light and the return signal light is reduced and thus the feedback interval can be shortened. That is, the interval of timing for performing the correction process can be shortened.

(4) The transceiver according to the above (2) or (3) further includes a beat detection unit that detects a frequency difference between return signal light received from the transceiver on the other side and the reference signal light, and a frequency shifting unit that frequency-shifts the return signal light such that the detected frequency difference becomes constant.

According to this configuration, the transceiver can make the frequency difference between the return signal light received from the transceiver on the other side and the reference signal light transmitted to the transceiver on the other side constant, such that it is possible to properly discriminate between the reference signal light and the return signal light.

(5) In the transceiver according to any one of the above (2) to (4), the frequency control unit demultiplexes, when the frequency control unit focuses the reference signal light to couple the reference signal light to an optical fiber, focused reference signal light and inputs demultiplexed light to the wavefront measurement unit as reference light.

According to this configuration, the spatial filtering unit for obtaining reference light from the reference signal light is unnecessary, such that the size of the transceiver can be reduced.

(6) A transceiver includes a beam splitter that transmits and reflects return signal light, which is reference signal light of a reference optical frequency transmitted from the transceiver via space and returned by a transceiver on another side, after the return signal light is received by the transceiver, a spatial filtering unit that extracts a plane wave component other than distortions from the return signal light reflected by the beam splitter and outputs extracted light as reference light, a wavefront measurement unit that measures a wavefront due to an interference between the reference light and the return signal light reflected by the beam splitter to detect a wavefront distortion of the return signal light, a spatial light modulation unit that wavefront-modulates the return signal light into a plane wave without wavefront distortions with a reversed wavefront distortion obtained by reversing the wavefront distortion and wavefront-modulates the reference signal light with the reversed wavefront distortion, and a frequency control unit that couples the return signal light transmitted through the beam splitter after being corrected by the spatial light modulation unit to an optical fiber to transmit the return signal light.

According to this configuration, the reference signal light on an outward path from the transceiver to the transceiver on the other side and the return signal light on a return path opposite to the outward path are wavefront-modulated with the reversed wavefront distortion at the same timing and in the same manner. When the reference signal light that the spatial light modulation unit has wavefront-modulated with the reversed wavefront distortion passes through an atmospheric fluctuation in the space and is received by the transceiver on the other side, the wavefront distortion due to the atmospheric fluctuation cancels out the opposite wavefront distortion due to the wavefront modulation, such that the reference signal light becomes signal light of a plane wave.

The atmospheric fluctuation causes a wavefront distortion to the return signal light into which the transceiver on the other side has returned the reference signal light of a plane wave. However, because the transceiver wavefront-modulates the return signal light with a reversed wavefront distortion obtained by reversing the wavefront distortion, the return signal light is corrected to a plane wave without wavefront distortions.

That is, because the wavefront modulation automatically produces phase conjugation between the reference signal light and the return signal light, wavefront distortions of both the reference signal light and the return signal light can be corrected and the light intensity can be stabilized by the correction.

(7) The transceiver according to the above (6) further includes a beat detection unit that detects a frequency difference between the return signal light from the transceiver on the other side and the reference signal light, and a frequency shifting unit that frequency-shifts the return signal light such that the detected frequency difference becomes constant.

According to this configuration, the transceiver can make the frequency difference between the return signal light from the transceiver on the other side and the reference signal light transmitted to the transceiver on the other side constant, such that it is possible to properly discriminate between the reference signal light and the return signal light.

(8) In the transceiver according to the above (6) or (7), the frequency control unit demultiplexes, when the frequency control unit focuses the return signal light to couple the return signal light to an optical fiber, focused return signal light and inputs demultiplexed light to the wavefront measurement unit as reference light.

According to this configuration, the spatial filtering unit for obtaining the reference light from the return signal light is unnecessary, such that the size of the transceiver can be reduced.

(9) A spatial light frequency transmission system includes the receiver according to the above (1) or the transceiver according to any one of the above (2) to (8).

According to this configuration, it is possible to accurately correct wavefront distortions caused mainly when reference signal light which is a light wave of the reference frequency is transmitted through the space.

(10) A spatial light frequency transmission method includes transmitting and reflecting, through and by a beam splitter, reference signal light of a reference optical frequency received by a receiver via space after being transmitted from a transmitter, extracting a plane wave component other than distortions from the reflected reference signal light and outputting extracted light as reference light, measuring a wavefront due to an interference between the reference light and the reference signal light reflected by the beam splitter to detect a wavefront distortion of the reference signal light, and wavefront-modulating the reference signal light received from the transmitter into a plane wave without wavefront distortions with a reversed wavefront distortion obtained by reversing the wavefront distortion.

According to this method, it is possible to extract a plane wave component other than distortions from the reference signal light received by the receiver. Because the plane wave component has a high light intensity, it is possible to prevent deterioration of the wavefront measurement accuracy and accurately correct wavefront distortions. In other words, it is possible to accurately correct wavefront distortions caused when reference signal light which is a light wave of the reference frequency is transmitted through the space.

(11) A spatial light frequency transmission method includes transmitting and reflecting, through and by a beam splitter, reference signal light of a reference optical frequency received by a transceiver via space after being transmitted from a transceiver on another side, coupling the transmitted reference signal light to an optical fiber to transmit the reference signal light and frequency-shifting and returning the reference signal light to use the reference signal light as return signal light to be transmitted back to the transceiver on the other side, extracting a plane wave component other than distortions from the reference signal light reflected by the beam splitter and outputting extracted light as reference light, measuring a wavefront due to an interference between the reference light and the reference signal light reflected by the beam splitter to detect a wavefront distortion of the reference signal light, and wavefront-modulating the received reference signal light into a plane wave without wavefront distortions with a reversed wavefront distortion obtained by reversing the wavefront distortion and wavefront-modulating the return signal light with the reversed wavefront distortion.

According to this method, the reference signal light on an outward path from the transceiver on the other side, which is received by the transceiver, and the return signal light on a return path opposite to the outward path are wavefront-modulated with the reversed wavefront distortion at the same timing and in the same manner. The reference signal light is wavefront-modulated with a reversed wavefront distortion obtained by reversing the wavefront distortion, such that the reference signal light is corrected to a plane wave without wavefront distortions.

Further, when the wavefront-modulated return signal light passes through an atmospheric fluctuation in the space and is received by the transceiver, the wavefront distortion due to the atmospheric fluctuation cancels out the opposite wavefront distortion due to the wavefront modulation, such that the return signal light becomes signal light of a plane wave. That is, because the wavefront modulation automatically produces phase conjugation between the reference signal light and the return signal light, wavefront distortions of both the reference signal light and the return signal light can be corrected and the light intensity can be stabilized by the correction.

Other appropriate changes can be made to the specific configurations without departing from the spirit of the present invention. In the spatial light frequency transmission system described above, internal processing of the transmitter and the receiver or the transceiver may be performed through electrical processing by photoelectric conversion, while spatial transmission is performed using optical signals.

### REFERENCE SIGNS LIST

1a, 1e Optical antenna
2a, 3e Frequency shifting unit
2e, 3a, 5a, 5e, 22b, 22c, 22d Multiplexing/demultiplexing unit
4a Beat detection unit
4e Reflection unit
10, 20, 20A, 20B, 30, 30A, 30B Spatial light frequency transmission system
11 Transmitter
11a, 12e, 21a, 22e Frequency control unit
12 Receiver
12a, 22a Spatial light modulation unit
12b, 12c, and 12d Beam splitter
12f, 12g Mirror
12h Spatial filtering unit
12i Wavefront measurement unit
13a, 13b Optical fiber
14 Reference signal source
15 Space
15a Atmospheric fluctuation
21, 22, 21A, 22A, 22B, 31A, 32A, 32B Transceiver

1. A receiver comprising:
a beam splitter configured to transmit and reflect reference signal light of a reference optical frequency received from a transmitter via space;
a spatial filtering unit configured to extract a plane wave component other than distortions from the reference signal light reflected by the beam splitter and output extracted light as reference light;
a wavefront measurement unit configured to measure a wavefront due to an interference between the reference light and the reference signal light reflected by the beam splitter to detect a wavefront distortion of the reference signal light; and
a spatial light modulation unit configured to wavefront-modulate the reference signal light received from the transmitter into a plane wave without wavefront distortions with a reversed wavefront distortion obtained by reversing the wavefront distortion.

2. A transceiver comprising:
a beam splitter configured to transmit and reflect reference signal light of a reference optical frequency received via space after being transmitted from a transceiver on another side;
a frequency control unit configured to couple the reference signal light that is transmitted to an optical fiber to transmit the reference signal light, frequency-shift and return the reference signal light, and transmit return signal light back to the transceiver on the other side;
a spatial filtering unit configured to extract a plane wave component other than distortions from the reference signal light reflected by the beam splitter and output extracted light as reference light;
a wavefront measurement unit configured to measure a wavefront due to an interference between the reference light and the reference signal light reflected by the beam splitter to detect a wavefront distortion of the reference signal light; and
a spatial light modulation unit configured to wavefront-modulate the reference signal light received from the transceiver on the other side into a plane wave without wavefront distortions with a reversed wavefront distortion obtained by reversing the wavefront distortion and wavefront-modulate the return signal light with the reversed wavefront distortion.

3. The transceiver according to claim 2, wherein the spatial light modulation unit is configured to, at next and subsequent timings after wavefront modulation of the reference signal light is performed at an initial timing, output a wavefront distortion caused to reference signal light received at a current timing in a wavefront portion other than a plane wave portion of reference signal light that is corrected to a plane wave through wavefront modulation at a previous timing as a difference between current reference signal light and previous reference signal light,
the wavefront measurement unit is configured to detect the difference, and
the spatial light modulation unit is configured to perform wavefront modulation of the current reference signal light with a reversed wavefront distortion obtained by reversing the difference that is detected.

4. The transceiver according to claim 2, further comprising:
a beat detection unit configured to detect a frequency difference between return signal light from the transceiver on the other side and the reference signal light; and
a frequency shifting unit configured to frequency-shift the return signal light to cause the frequency difference that is detected to become constant.

5. The transceiver according to claim 2, wherein the frequency control unit is configured to, when the frequency control unit focuses the reference signal light to couple the reference signal light to an optical fiber, demultiplex focused reference signal light and input demultiplexed light to the wavefront measurement unit as reference light.

6. A transceiver comprising:
a beam splitter configured to transmit and reflect return signal light after the return signal light is received by the transceiver, the return signal light being reference signal light of a reference optical frequency transmitted from the transceiver via space and returned by a transceiver on another side;
a spatial filtering unit configured to extract a plane wave component other than distortions from the return signal light reflected by the beam splitter and output extracted light as reference light;
a wavefront measurement unit configured to measure a wavefront due to an interference between the reference light and the return signal light reflected by the beam splitter to detect a wavefront distortion of the return signal light;
a spatial light modulation unit configured to wavefront-modulate the return signal light into a plane wave without wavefront distortions with a reversed wavefront distortion obtained by reversing the wavefront distortion and wavefront-modulate the reference signal light with the reversed wavefront distortion; and
a frequency control unit configured to couple the return signal light transmitted through the beam splitter after being corrected by the spatial light modulation unit to an optical fiber to transmit the return signal light.

7. The transceiver according to claim 6, further comprising:
a beat detection unit configured to detect a frequency difference between the return signal light received from the transceiver on the other side and the reference signal light; and
a frequency shifting unit configured to frequency-shift the return signal light to cause the frequency difference that is detected to become constant.

8. The transceiver according to claim 6, wherein the frequency control unit is configured to, when the frequency control unit focuses the return signal light to couple the return signal light to an optical fiber, demultiplex focused return signal light and input demultiplexed light to the wavefront measurement unit as reference light.

9. A spatial light frequency transmission system comprising the receiver according to claim 1.

10. (canceled)

11. (canceled)

12. The transceiver according to claim 6, wherein the spatial light modulation unit is configured to, at next and subsequent timings after wavefront modulation of the reference signal light is performed at an initial timing, output a wavefront distortion caused to reference signal light received at a current timing in a wavefront portion other than a plane wave portion of reference signal light that is corrected to a plane wave through wavefront modulation at a previous timing as a difference between current reference signal light and previous reference signal light,
the wavefront measurement unit is configured to detect the difference, and
the spatial light modulation unit is configured to perform wavefront modulation of the current reference signal light with a reversed wavefront distortion obtained by reversing the difference that is detected.

13. A spatial light frequency transmission system comprising the transceiver according to claim 2.
